(19) United States
(12) Patent Application Publication
(10) Pub. No.: US 2017/0274826 A1
(43) Pub. Date: Sep. 28, 2017

(54) New rear view mirror configuration structures give the driver complete unabridged wide rear visual field that help the drivers safely operating vehicles in all kinds of situations

(71) Applicants: Yongdong Zhou, Oak Ridge, TN (US); Xiao Zhou, Oak Ridge, TN (US); Jianhua Wan, Oak Ridge, TN (US)

(72) Inventors: Yongdong Zhou, Oak Ridge, TN (US); Xiao Zhou, Oak Ridge, TN (US); Jianhua Wan, Oak Ridge, TN (US)

(21) Appl. No.: 14/999,072

(22) Filed: Mar. 28, 2016

(51) Int. Cl. B60R 1/08; B60R 1/04

(52) U.S. Cl. CPC B60R 1/082; B60R 1/04

(57) ABSTRACT

This invention of special rear view mirror structures gives a complete unabridged wide rear view field of both untwisted and twisted image zones that better helps the drivers safely operating their cars and trucks in all kinds of situations.

### TECHNICAL FIELD

This invention relates to rear view mirrors, and more particularly at current time, to automobiles and commercial truck equipment.

### BACKGROUND ART

Rear mirrors are very important tools for the safety of operating automobiles, especially for the safety of operating commercial trucks. Each car is now typically equipped with three rear view mirrors, which are located at the driver side, passenger side, and to the center upper position on the wind-shield, to help the drivers in operating their automobiles, such as during the lane changing, backing, etc. There are two kinds of auto mirrors which are currently in use. The first kind is the plane mirrors, which also called flat mirrors. And the other kind of mirrors are convex mirrors, which are more commonly called blind spot mirrors and most typically are just spherical mirrors.

A plane mirror images the real world in front of it exactly the same size, except the right side to the left side and the left side to the right, into the rear side of the mirror forms the image world of the real world. They are widely used in our daily life for all kinds of purposes everywhere. Everybody uses them every day, especially for some of the ladies. We everybody know so well how a mirror works and how the image world inside the mirror representatives the real world in front of the mirror. Plane mirrors are standard equipment to every kind of automobiles. One mirror works just like another eye watching the rear side around automobiles that helps the drivers during a particular operation in processing.

When you check the rear side through a plane rear view mirror, just like the image “you” inside the image world checks directly the rear side in real world through the mirror. The plane mirror is just like a window between the image world and the real world. So the visual fields to both you and the image “you” inside the image world are limited by the size of the plane mirror, the “window” between the two worlds, and the distance from your eyes to the mirror/“window”. The larger size mirror that you are using, you will get the larger effective rear view field. The closer the mirror that is located to your eyes, you will have larger effective rear view field also. But the size of applied rear view mirrors is limited. So the effective rear view field of a plane rear view mirror is very limited, especially to those plane rear view mirrors that equip to the passenger side, because they are further away from the drivers. The drivers normally prefer to check the center rear view mirror since it is the closest rear view mirror from the driver's eyes and normally gives the largest rear view field.

Yes, the drivers can always move their head around to scan the effective rear view fields from rear view mirrors, but this would not make a big difference. You will always have blind areas around your automobiles behind and to the side that are hard to be seen by simply checking plane rear view mirrors no matter how hard you move your head around. So the drivers are requested to turn their heads around to check the blind spot through the windows behind before make a lane change. This would not work to Commercial Truck (CT) drivers because commercial trucks have only one window at each side of trucks and there is not any window behind the drivers. CT drivers have to pretty much rely on all kinds of rear view mirrors equipped everywhere around CT to make safe driving operations. A smart rear view mirror that could lively scan around according to the demand and need of the driver would be a perfect solution. But the cost of these smart mirrors is a problem for every driver to own this smart system, even though it could be done with nowadays technology.

Now use of only simple plane rear view mirrors is not good enough for commercial transportation, even though the plane rear view mirrors of CTs are times larger than those of the personal automobiles. Blind Spot (BS) rear view mirrors are the must for Commercial Truck driving and there are at least three BS rear view mirrors that are equipped to each CTs, many CTs are even equipped with up to six, and may be even more, BS rear view mirrors all around the CT bodies.

To insure the rear view field technologies that are safely enough for CT driving, Blind Spot rear view mirrors of convex mirror structures are applied as a standard equipment, most commonly used in current market are just spherical mirrors. The convex mirrors collect lights from much wider directions from behind and to the side and send them to the driver's eyes. Their imaging mechanisms are totally different from plane mirrors. You can find your image inside a convex mirror in image world is much smaller than real you, and the real world has been significantly reduced in size inside the image world behind convex mirrors, in which also the right to left and the left to right, but the relative positions remains the same order. The image of you surely is much closer to the convex mirror, or the “window” between the real world and the image world, than that of you to the convex mirror in real world. Now the effective rear view field you get through a convex mirror is significantly enlarged since your eye's image is very close to the mirror/window in image world for you to check the rear side in real world.

Convex rear view mirrors have been doing such a good job in widening rear view field, and are equipped on every commercial truck. By using proper convex rear view mirrors, the blind spots around the trucks are pretty much eliminated and millions of CTs are safely traveling on the States' public transportation road net every day operated by our very respectful experienced commercial truck drivers everywhere. But convex mirrors twist the image world so much and make it very hard to judge the exact real distances and positions of the other automobiles that are travelling around you behind and to the side. Drivers are still preferred a lot on checking the two main plane rear view mirrors than checking the useful convex BS rear view mirrors. We are introducing a special kind of useful rear view mirrors in this invention that will better help the drivers in operating the automobiles and also the commercial trucks in all kinds of situations.

### SUMMARY OF INVENTION

### Technical Problem

There are mainly two kinds of rear view mirrors in current market helping the drivers in safely operating all kinds of automobiles and commercial trucks. The first kind of rear view mirrors is plane mirrors. It gives the drivers the best rear view, but very limited size of rear view field. The other kind of rear view mirrors is made of convex mirrors, more commonly called blind spot rear view mirrors. It does a great job on widening the rear view field, but gives twisted rear view that makes it very hard to judge the real distances and exactly locations of the other automobiles that are traveling around behind and to the sides. Peoples have to turn their head around to check the blind spots behind and to the side of them before making a safe lane change if they do not equipped with BS rear view mirrors. Commercial trucks have to equip many rear view mirrors of both kinds of them helping the commercial truck drivers in safely operating their commercial trucks, which make the everyday operations very hard and complex.

Many efforts have been made on improving the functions of the important rear view mirror technologies, such as enlarging rear view mirror size⁽¹⁾, adjusting mounted rear view mirror's positions^{(2), (3)}, rear view mirror remote controlling^{(4), (5)}, rear view mirror rotation^{(6), (7)}, cleaning rear view mirrors^{(8), (9)}, etc.^{(10), (11)} We are presenting this invention that will fundamentally change the current rear view mirror technologies.

### Solution to Problem

The idea of this new invention of unique rear view mirror structures is displayed in FIG. 1. A, which combined of 2, 1 and 3 from a to b to c and to d, is the cross section of invented rear view mirror that combines mainly of two regions. The main center region 1, from b to c, is simply made of plane mirror that gives an untwisted rear view of 10, in which the drivers can easily judge the exact distances, heights, sizes, shapes, and the locations of the automobiles, objects, people, docks, cargos, walls, doors, etc. that locate around the drivers behind and to the side when they are critically maneuvering their cars or trailers and trucks, such as backing the trailer and truck into a tight dock. Because 1 is simply a plane mirror structure, the rear view field 10 is very limited to that the real world associate behind and to the side to be seen. The outer side mirror region 2 and 3 of the invented rear view mirror A, which is from a to b and c to d respectively, are made of convex mirrors. Convex region 2 that from a to b gives drivers a wide rear view field of 20 covers the wide left side (or the upper side) part of the real world that locates just to the untwisted rear view field of 10 that given by the invented mirror A's center plane region 1. The rear view field 20 could be very wide that covers pretty much the whole left or upper side view of the real world from the untwisted rear view region of 10, depends on the need and design of the actually convex mirror structure, of cause pays by twisting the image in the region of 20. Convex region 3 that from c to d gives drivers a wide rear view field of 30 covers the right side (or the down side respectively) part of the world that locates just to the right of the untwisted rear view field of 10 that given by the invented mirror A's center plane mirror region 1. The rear view field 30 could be also very wide that covers pretty much the whole right or down side view of the real world from the untwisted rear view region of 10, of cause pays by twisting the image in region 30 as well. The center plane region 1 of the invented rear view mirror A is tangential to the entire outer convex region 2 and 3 at b and c respectively everywhere that ensures both the outside rear view field region 20 and 30 anastomoses perfectly to the center untwisted rear view field region 10. In the other words, the center plane region 1 of the invented rear view mirror A must anastomose perfectly and smoothly to the entire outer side convex region 2 and 3 everywhere and also in all directions so that the entire outer side widened twisted rear view fields of 20 and 30 meet with the untwisted rear view field of 10 perfectly, and there is absolutely not any missing parts from the real world behind and to the side, neither overlapped parts from the real world behind and to the side happens between the outer twisted rear view field 20 or 30 and the center untwisted view field 10. The invented new rear view mirrors A collects the lights widely from all over behind and to the side and sends them to the driver's eye 5 helping the drivers making judgments and decisions for safely operating the cars and trucks in all kinds of situations. If the actual center plane region 1 of the invented new rear view mirror A is simply a circular plane mirror, the entire rear invented rear view mirror A now just like to be formed by rotating the curve “abcd” in FIG. 1 around the center point of A. The rear view mirror now could be a 360° degree symmetrically structure that gives the driver an untwisted rear view 10 through the center circular plane region 1 and an wide but angularly twisted rear view field right from the outside edge of the untwisted rear view 10. Drivers can rotate the invented rear mirror A aiming the untwisted rear view field 10 to the important region where he need to check exact locations and distances of those to his best interest while still capable of keeping an eye on what is and going on there right outside the important region 10, and get prepared in advance to those which could enter the region 10 of his best interest nest.

If the center plane region 1 of the invented new rear view mirror A is simply made to be a rectangular plane mirror, the entire invented rear view mirror A now can be combined with a rectangular center plane region, four edge regions of cylindrical surface structures to the left, right, up, and down sides, and four corner regions of ellipsoidal or spherical surface structures, just like to scan the curve “abcd” in FIG. 1 up and down, right and left to form the main structure of the entire invented rear mirror A. Of course the center plane region and all the convex mirror regions of the edge cylindrical regions and the corner ellipsoidal regions are smoothly and tangentially connected together everywhere and in all directions so the entire invented mirror structure A gives a complete unabridged rear visual field that has absolutely not any missing parts, neither over lapped images from the real world behind and to the side of the drivers. The rear view mirror A now gives the driver an untwisted rear view field 10 through the main rectangular center plane region 1 that just like what the driver sees from a current market rear view mirror every day, one dimensionally widened but twisted to the center rear view fields right from the four edges of each side of the untwisted rear view 10 through the four edge cylindrical regions, and two dimensionally widened but twisted rear view fields from the four corner areas of the real world through the four corner ellipsoidal surface regions. The entire visual field from different parts of the rear world, which may not be twisted, one dimensionally twisted or even two dimensionally twisted, has absolutely not any missing part, neither any overlapping part. Drivers can rotate the invented mirror A aiming the untwisted rear view field 10 to the important region behind and to the side where to his best interest checking the exact locations and distances of the objects while still keeping an eye on what is and going on there around, and getting prepared in advance to those which could enter the interest zone nest.

It may not be needed to use the entire invented structure of the rear view mirror A described above for certain applications. For example, just half of the invented structure described above might be enough for an application. Cut the invented structure that described above to be half and put the left half to the driver side to check the behind and to the left, up, and down side views of the automobile and put the right half to the passenger side to check the behind and to the right, up, and down side views of the automobile.

Even just quarter of the invented structure A described above might be good enough to do the jobs. Cut the invented structure that described above to be four pieces and put either the left-upper quarter or the left-lower quarter to the driver side to check the behind and to the left and up or down side views of the automobile, and put either the right-upper quarter or the right-lower quarter to the passenger side to check the behind and to the right and up or down side views of the automobile.

We can just use even less part of the invented rear view mirror configuration structures A described ahead which comprising of only a rectangular plane region and a left edge cylindrical region that described above to the driver side to check the behind and to the left side views of the automobile, and a rear view mirror configuration structures that comprising of only a rectangular plane region and a right edge cylindrical region that described above to the passenger side to check the behind and to the right side views of the automobile.

### Advantageous Effects of this Invention

This invention of new rear view mirror configuration structures can do both the jobs of the current standard plane rear view mirrors and the current blind spot mirrors. It will simplify the rear view mirror technologies by using less rear view mirrors but harvest better rear view effects. Drivers can rotate both their plane mirrors and also the blind spot mirrors together by just pushing the remote-control buttons inside sitting on their driving chair while even driving.

### REFERENCES

(1). Extra Large Truck Mirror, Peter John Whitehead, James A. Wollmer, and Greg David Volovsek, U.S. Pat. No. D748,546S, Feb. 2, 2016
(2). Adjustable Truck Mirror, Ian Boddy, Ada, Mich., U.S. Pat. No. 5,483,385, Jan. 9, 1996.
(3). Truck Mirror Adjustable in the Horizontal Direction, Harold Deedreek, U.S. Pat. No. 4,558,930, Dec. 17, 1985.
(4). Cable Kit Making a Remote Controlled Truck Mirror, Raymond Jackson, U.S. Pat. No. 4,157,862, Jun. 12, 1979.
(5). Drive Device for Truck Mirror, Russell Keast, U.S. Pat. No. 5,111,341, May 5, 1992.
(6). Rotating Rear View Truck Mirror, Joel W. Higdon, U.S. Pat. No. Des. 303,515, Sep. 19, 1989.
(7). Exterior Rearview Truck Mirror, Michael J. Maccan, U.S. Pat. No. 5,760,956, Jun. 2, 1998.
(8). Self Cleaning Truck Mirror, George L. Raynor, U.S. Pat. No. 4,870,713, Oct. 3, 1989.
(9). Rearview Truck Mirror and Wiper Assembly, William Q. Cowan, U.S. Pat. No. 6,654,982 B1, Dec. 2, 2003.
(10). Truck Mirror and Wind Scoop Assembly, Drew P. Garland, Brian P. Garland, Tony Abee, U.S. Pat. No. 5,815,315, Sep. 29, 1998.
(11). Truck Mirror with Overlying Bottom End Cover, Arthur F. Bleiweiss, Dimitru Cotoara, Robert J. Wilkes, U.S. Pat. No. 4,344,672, Aug. 17, 1982.

### BRIEF DESCRIPTION OF THE DRAWING

A better understanding of this invention can be gained from a consideration of the following detailed description of the preferred embodiments thereof, in conjunction with the appended drawing, wherein:

FIG. 1 the cross section configuration of an unique invention rear view mirror structure A is displayed in FIG. 1, which combined of a plane mirror region 1 from b to c, and outside convex regions of 2 & 3, from a to b to c and to d respectively. The main center region 1, from b to c, is simply made of plane mirror that gives the driver's eye 5 an untwisted rear view field of 10, in which drivers can judge exact distances, heights, sizes, shapes, and locations of automobiles, objects, docks, cargos, walls, doors, etc. to the driver's best interests that locate behind and to the sides of the drivers when they are maneuvering their cars or trucks and trailers, such as backing their truck and trailer into a tight dock. The outside regions 2 and 3 of the invented rear view mirror A, which is from a to b and c to d respectively, are made of convex mirrors. Convex region 2 that from a to b gives drivers a very wide rear view field 20 that covers the left side (or the upper side) part of the world that locates just to the untwisted rear view field 10 that given by the invented rear view mirror A's center plane region 1. The rear view field 20 could be very wide that covers pretty much the whole left or upper side view of the real world to the untwisted rear view region of 10, of cause pays by twisting the image in the region of 20. Convex mirror region 3 that from c to d gives the drivers a very wide rear view field of 30 covers the right side (or the down side respectively) part of the world that locates to the right of the untwisted rear view field 10 that given by the invented rear view mirror A's center plane region 1. The rear view field 30 could be also very wide that covers pretty much the whole right or down side view of the real world to the untwisted rear view region of 10, of cause pays by twisting the image in region of 30. The center plane region 1 of the invented rear view mirror A is anastomosed smoothly and tangentially to all the outside convex regions 2 and 3 at b and c respectively everywhere and in all directions that ensures the outer rear view field region 20 and 30 fits to the center untwisted rear view field region 10 perfectly. In the other words, the center plane region 1 of the invented rear view mirror A must anastomose perfectly and smoothly to the entire outer side convex region 2 and 3 everywhere and also in all directions so that the entire outer side widened twisted rear view region of 20 and 30 meets with the untwisted rear view region of 10 perfectly, and there is absolutely no any missing parts from the real world behind and to the side, neither overlapped parts from the real world behind and to the side happening between the outside twisted rear view field 20 or 30 and the center untwisted view field 10. The invented new rear view mirrors A collects the lights widely from all over behind and to the side and sends them to the driver's eye 5 helping the drivers making judgments and decisions for safely operating the cars and trucks in all kinds of situations.

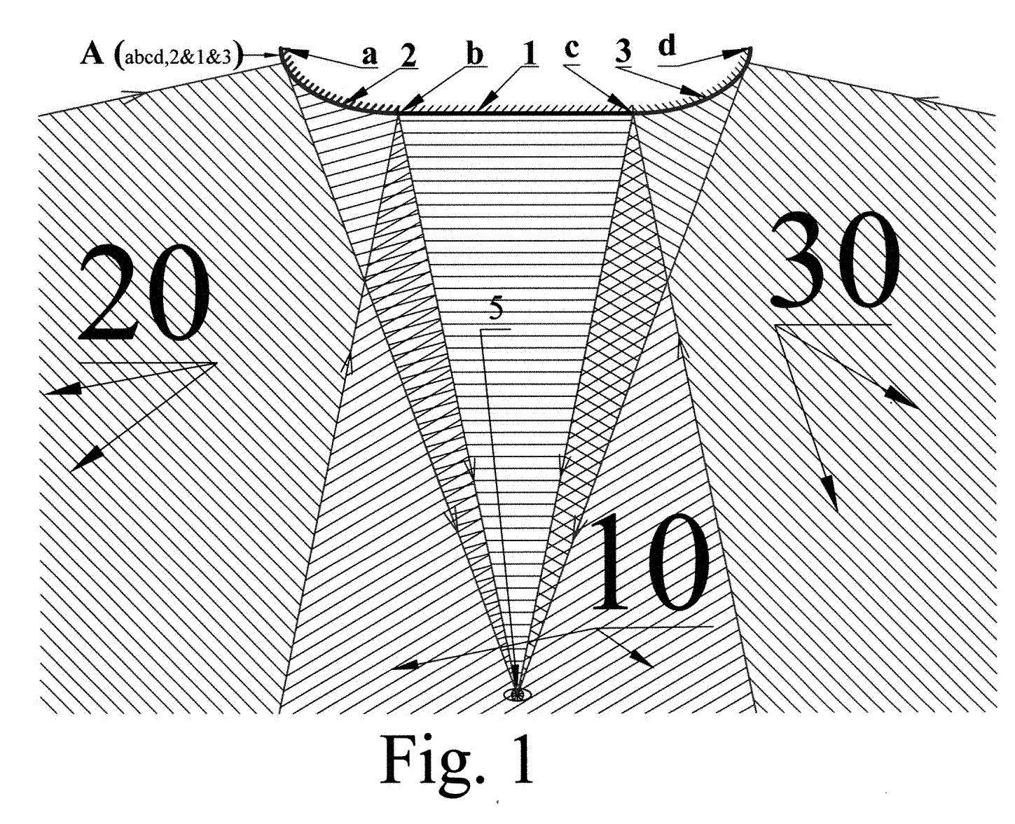

1. A rear view mirror structure comprising: a center plane mirror region and outside convex mirror regions; in which said center plane mirror region has being smoothly and tangentially combined to all said outside convex mirror regions everywhere and in all directions; in which every said outside convex mirror regions have also been smoothly and tangentially anastomosed each other together everywhere and in all directions; where in the entire complete unabridged wide rear view field giving by said rear view mirror structure has absolutely not any missing views neither over lapping views between those from said center plane mirror region and said outside convex mirror regions.

2. A rear view mirror structure comprising: a plane mirror region and convex mirror regions; in which all said plane mirror region and said convex mirror regions have been smoothly and tangentially anastomosed together everywhere and in all directions; where in the entire complete unabridged wide rear view field giving by said rear view mirror structure has absolutely not any missing views neither over lapping views between those from said plane mirror region and said convex mirror regions.

3. A rear view mirror structure comprising: a plane mirror region and a convex mirror region; in which said plane mirror region has been smoothly and tangentially anastomosed to said convex mirror region everywhere and in all directions; where in the entire complete unabridged wide rear view field giving by said rear view mirror structure has absolutely not any missing views neither over lapping views between those from said plane mirror region and said convex mirror region.
